(19) United States
(12) Patent Application Publication
(10) Pub. No.: US 2024/0330406 A1
(43) Pub. Date: Oct. 3, 2024

(54) INFORMATION-PROCESSING DEVICE, INFORMATION-PROCESSING METHOD, AND COMPUTER-READABLE STORAGE MEDIUM

(71) Applicant: HONDA MOTOR CO., LTD., Tokyo (JP)

(72) Inventors: Sho Nakajima, Wako-shi (JP); Atsushi Yamamoto, Wako-shi (JP); Jun Okano, Wako-shi (JP)

(21) Appl. No.: 18/582,710

(22) Filed: Feb. 21, 2024

(30) Foreign Application Priority Data
Mar. 31, 2023 (CN) 202310342249.X

(51) Int. Cl. G06F 17/18

(52) U.S. Cl. CPC G06F 17/18

(57) ABSTRACT

An information-processing method executed by an information-processing device includes: generating a new individual by changing a value of part of explanatory variables of an individual selected with a first probability from current generation data, which has n individuals (n is an integer of three or more) and in which each individual is an explanatory variable group having a plurality of explanatory variables, to a target value based on a value of a corresponding explanatory variable of another individual; generating a new individual by changing a value of part of explanatory variables of an individual selected with a second probability from the current generation data to another value; and selecting n individuals of next generation data from the n individuals and the generated individual based on a fitness degree calculated from an explanatory variable group for each individual, wherein an explanatory variable having a value defined by a combination condition is set to take a value represented by one of a plurality of combinations constituted of a plurality of values determined in advance.

### CROSS-REFERENCE TO RELATED APPLICATION

Priority is claimed on Chinese Patent Application No. 202310342249.X, filed on Mar. 31, 2023, the contents of which are incorporated herein by reference.

### BACKGROUND

### Field of the Invention

The present invention relates to an information-processing device, an information-processing method, and a computer-readable storage medium.

### Background

Product design can be understood as a multi-objective optimization problem that pursues a plurality of objectives. For example, in battery design, an increase of a capacity, an increase of an output, reduction of production costs, and the like are pursued. Evolutionary algorithms may be used in the multi-objective optimization problem. Among the evolutionary algorithms, for example, a non-dominated sorting genetic algorithm (NSGA-II) may be used. As the related art, for example, technologies described in Japanese Unexamined Patent Application, First Publication No. 2011-187056, Japanese Unexamined Patent Application, First Publication No. 2019-191887, Japanese Unexamined Patent Application, First Publication No. 2020-106957, Japanese Patent No. 5235652, and Japanese Patent No. 6918681 are disclosed.

### SUMMARY

When multi-objective optimization is performed using an evolutionary algorithm, the algorithm attempts to calculate a Pareto solution with a higher fitness degree. Therefore, in product design or the like, a combination of explanatory variables that cannot be realized may be output.

An object of an aspect of the present invention is to provide an information-processing device, an information-processing method, and a computer-readable storage medium that calculate a feasible combination of solutions.

An information-processing method according to a first aspect of the present invention is an information-processing method executed by an information-processing device, including: generating a new individual by changing a value of part of explanatory variables of an individual selected with a first probability from current generation data, which has n individuals (n is an integer of three or more) and in which each individual is an explanatory variable group having a plurality of explanatory variables, to a target value based on a value of a corresponding explanatory variable of another individual; generating a new individual by changing a value of part of explanatory variables of an individual selected with a second probability from the current generation data to another value; and selecting n individuals of next generation data from the n individuals and the generated individual based on a fitness degree calculated from an explanatory variable group for each individual, wherein an explanatory variable having a value defined by a combination condition is set to take a value represented by one of a plurality of combinations constituted of a plurality of values determined in advance.

A second aspect is the information-processing method according to the first aspect described above, wherein an explanatory variable having a value that is not defined by a combination condition may take a value within a set range when the explanatory variable is a continuous value, and the explanatory variable may take one of a plurality of candidate values when the explanatory variable is a discrete value.

A third aspect is a computer-readable storage medium that stores a computer program causing a computer of an information-processing device to execute the information-processing method of the first aspect described above.

An information-processing device according to a fourth aspect of the present invention includes: a storage portion that stores current generation data which has n individuals (n is an integer of three or more) and in which each individual is an explanatory variable group having a plurality of explanatory variables; and an individual process portion that generates a new individual by changing a value of part of explanatory variables of an individual selected with a first probability from the current generation data to a target value based on a value of a corresponding explanatory variable of another individual, generates a new individual by changing a value of part of explanatory variables of an individual selected with a second probability from the current generation data to another value, and selects n individuals of next generation data from the n individuals and the generated individual based on a fitness degree calculated from an explanatory variable group for each individual, wherein an explanatory variable having a value defined by a combination condition is set to take a value represented by one of a plurality of combinations constituted of a plurality of values determined in advance.

According to the first to fourth aspects, it is possible to calculate a feasible solution.

### BRIEF DESCRIPTION OF THE DRAWINGS

FIG. 1 is a schematic block diagram showing an example of a functional configuration of an information-processing device according to the present embodiment.

FIG. 2 is a schematic block diagram showing a hardware configuration example of the information-processing device according to the present embodiment.

FIG. 3 is an overhead view showing an example of information processing according to the present embodiment.

FIG. 4 is a view showing an example of a type of an explanatory variable according to the present embodiment.

FIG. 5 is a view showing an example of a constraint condition according to the present embodiment.

FIG. 6 is a flowchart showing another example of information processing according to the present embodiment.

### DESCRIPTION OF EMBODIMENTS

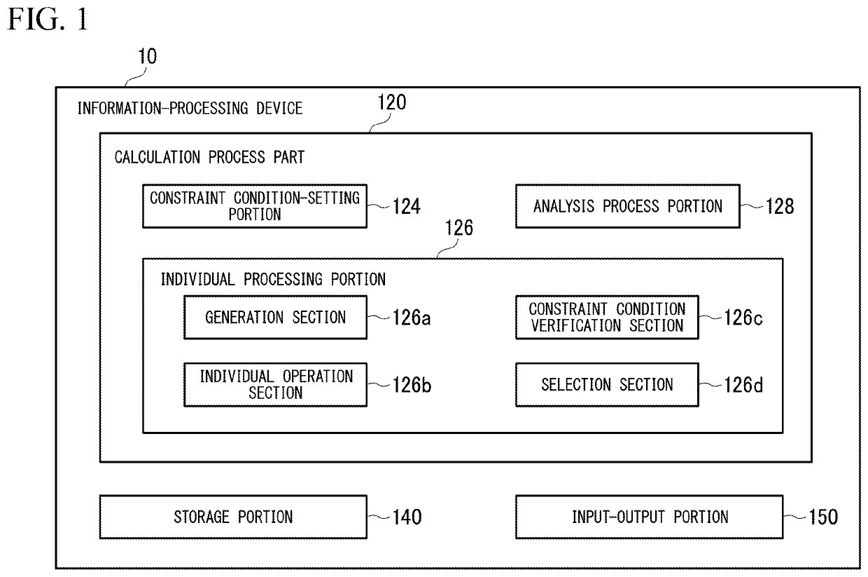

Embodiments of the present application will be described with reference to the drawings. FIG. 1 is a schematic block diagram showing an example of a functional configuration of an information-processing device 10 according to the present embodiment. The information-processing device 10 according to the present embodiment acquires product data and stores the acquired product data. The product data has n individuals (n is a predetermined integer of two or more). Each individual constitutes an explanatory variable group having a plurality of explanatory variables representing a production condition of each product. Production conditions of a product include a material, a design matter, or the like of a product. The explanatory variable group is used for prediction of the performance of a product produced in accordance with a production condition. The information-processing device 10 calculates a fitness degree indicating an overall performance of the product on the basis of an objective variable. The objective variable is an index indicating an individual element of performance. The information-processing device 10 calculates an objective variable using a learning model for an explanatory variable group.

The information-processing device 10 performs a process for solving a multi-objective optimization problem using an evolutionary algorithm on product data. The information-processing device 10 performs: a crossover process of generating a new individual by changing values of some explanatory variables of an individual selected with a predetermined first probability from current generation product data (hereinafter, referred to as “current generation data”) having n individuals to values determined based on values of corresponding explanatory variables of another individual; a mutation process of generating a new individual by changing values of some explanatory variables of an individual selected with a second probability from the current generation data to other values; and a selection process of selecting n individuals of next generation data on the basis of a fitness degree calculated from an explanatory variable group for each individual from the stored individuals and the generated individuals. Accordingly, for each generation, on the basis of the fitness degree, some individuals are rejected and replaced with new individuals.

Next, an example of a functional configuration of the information-processing device 10 is described. The information-processing device 10 includes a calculation process part 120, a storage portion 140, and an input-output portion 150.

The calculation process part 120 includes a constraint condition-setting portion 124, an individual process portion 126, and an analysis process portion 128.

The constraint condition-setting portion 124 sets a constraint condition to be imposed on an explanatory variable group that forms each individual and stores constraint condition information indicating the set constraint condition in the storage portion 140.

The constraint conditions are classified into an individual constraint condition applied to a single explanatory variable and a combination condition applied to a plurality of explanatory variables. The individual constraint condition mainly defines a range of explanatory variables. More specifically, the individual constraint condition can indicate whether a type of an explanatory variable is a continuous value or a discrete value, and one or both of maximum and minimum possible values are indicated. For the discrete value, a plurality of candidate values can be specified instead of the maximum or minimum value.

The combination condition specifies a combination of possible values of a plurality of explanatory variables. The combination is a combination of explanatory variables that can be used as a production condition of a product.

An explanatory variable that is defined as a continuous value by the individual constraint condition is called a continuous value type, an explanatory variable that is defined as a discrete value is called a discrete value type, and an explanatory variable having a value defined by a combination condition is called a combination type. The individual constraint condition and the combination condition apply exclusively and do not apply redundantly. That is, either the individual constraint condition or the combination condition applies to one type of explanatory variable.

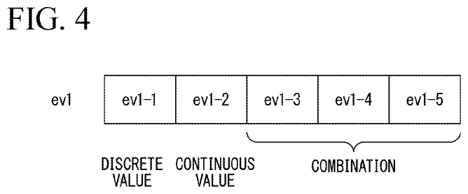

In the example of FIG. 4, in an individual ev1, an explanatory variable ev1-1 is a discrete value type, and an explanatory variable ev1-2 is a continuous value type. The explanatory variable ev1-1 takes any one of a plurality of candidate values, and the explanatory variable ev1-2 takes a value within a range set as the individual constraint condition. Further, explanatory variables ev1-3, ev1-4, and ev1-5 are the combination type. The explanatory variables ev1-3, ev1-4, and ev1-5 take a value indicated by one combination.

All of the explanatory variables of the combination type may not be in a dependent relationship. For example, in an individual ev1, when explanatory variables ev1-1, ev1-2, ev1-3, and ev1-4 are the combination type, the explanatory variables ev1-1 and ev1-2 may take a value indicated by one of a plurality of combinations, and the explanatory variables ev1-3 and ev1-4 may take a value indicated by one of a plurality of combinations that differ from those of the explanatory variables ev1-1 and ev1-2. At this time, the value of the explanatory variable ev1-1 is dependent on the explanatory variable ev1-2 but is determined independently of the explanatory variables ev1-3 and ev1-4.

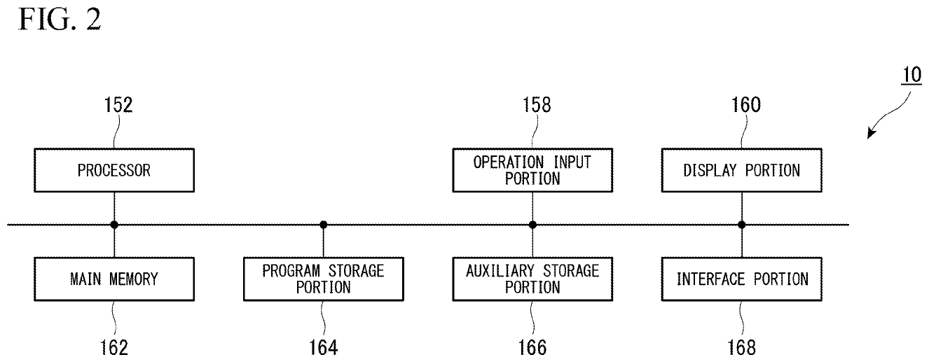

The constraint condition-setting portion 124 adds, changes, or deletes various constraint conditions, for example, in accordance with operation information input from an operation input portion 158 (FIG. 2). The constraint condition-setting portion 124 may acquire constraint condition information indicating a constraint condition from another device. Specific examples of the constraint condition will be described later. The individual process portion 126 includes a generation section 126a, an individual operation section 126b, a constraint condition verification section 126c, and a selection section 126d.

The generation section 126a reads the constraint condition information stored in the storage portion 140, refers to the read constraint condition information, and specifies a constraint condition applied to each explanatory variable.

The generation section 126a generates n individuals as initial individuals so as to satisfy the specified constraint condition and constitutes first generation product data including the generated initial individuals. The generation section 126a stores, in the storage portion 140, the constituted product data as first generation data.

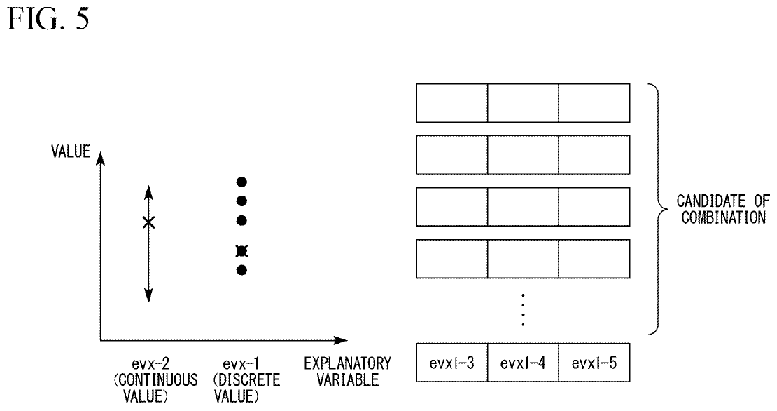

When generating the initial individual, the generation section 126a sets, for each explanatory variable constituting each individual, a value of the explanatory variable so as to satisfy a constraint condition imposed on each explanatory variable. For example, for an explanatory variable of the continuous value type that takes a continuous value in which a maximum value and a minimum value are defined, the generation section 126a randomly selects one real value within a range between the minimum value and the maximum value as a value of the explanatory variable. For an explanatory variable of the discrete value type, the generation section 126a randomly selects one of candidates for a plurality of possible values as a value of the explanatory variable. For an explanatory variable of the combination type, the generation section 126a randomly selects one of candidates for combinations of a plurality of values as a combination of the plurality of values of the explanatory variable (refer to FIG. 5 with respect to a selection method). In the present application, “randomly” means stochastically, more specifically, determining a value using pseudo-random numbers. The selected combinations may have a priority order, and a probability with which the generation section 126a selects, for example, a predetermined combination may be large or small. Further, the generation section 126a may not select a predetermined combination.

The crossover process includes the following processes of S62 to S68.
(S62) A focus explanatory variable that is part of the explanatory variables of a focus individual to be processed is randomly selected from n parent individuals.
(S64) A reference individual to be referred to is randomly selected from the remaining n−1 parent individuals.
(S66) A first target value is determined for the focus individual on the basis of a value of the focus explanatory variable of the reference individual. Further, a second target value is determined for the reference individual on the basis of the value of the focus explanatory variable of the focus individual.
(S68) A new individual is generated as a child individual by replacing the value of the focus explanatory variable of the focus individual with the first target value and maintaining the values of the other explanatory variables. A new individual formed by replacing the value of the focus explanatory variable of the reference individual with the second target value and maintaining the values of the other explanatory variables is generated as a child individual.

The individual operation section 126b repeats the processes of S62 to S68 until the number of child individuals reaches p (p is a predetermined integer larger than 1 and less than n). p/2n corresponds to a crossover rate. The number p of child individuals is set in advance on the basis of the crossover rate in the individual operation sections 126b.

In the process of S66, a method of determining a target value to be set for the focus explanatory variable differs depending on whether the focus explanatory variable is the continuous value type or the discrete value type. For example, when the focus explanatory variable is the discrete value type, the individual operation section 126b determines the value of the focus explanatory variable of the reference individual and the value of the focus explanatory variable of the focus individual as the first target value and the second target value, respectively (uniform crossover). When the focus explanatory variable is the continuous value type, the individual operation section 126b determines the first target value and the second target value using a SBX (Simulated Binary Crossover) method. The SBX method includes: a process of setting a predetermined first probability distribution and a predetermined second probability distribution that have centers of gravity at the value of the focus explanatory variable of the reference individual and the value of the focus explanatory variable of the focus individual and are symmetrical to each other; and a process of randomly determining the first target value in accordance with the first probability distribution and randomly determining the second target value in accordance with the second probability distribution.

For example, for a focus explanatory variable ev1-2 which is a continuous value, the original value ev1-2 is replaced by a second target value ev2-2′ using a probability density function around the focus explanatory variable ev2-2 of the reference individual ev2 on the basis of the SBX method. For a focus explanatory variable ev1-1 which is a discrete value, the original value ev1-1 is replaced by a second target value ev2-1 in the corresponding focus explanatory variable ev2-1 of the reference individual ev2. An explanatory variable group including the replaced value of the focus explanatory variable and values of the other explanatory variables of the focus individual is generated as a child individual ev1′.

The individual operation section 126b selects a possible combination by the uniform crossover for the explanatory variable of the combination type. The selected combinations may have a priority order similarly to the generation of the initial individual, and a probability with which the individual operation section 126b selects, for example, a predetermined combination may be large or small. Further, the individual operation section 126b may not select a predetermined combination.

A mutation process includes the following processes of S82 and S84.
(S82) A focus explanatory variable that is part of the explanatory variables of the focus individual to be processed is randomly selected from n parent individuals at a predetermined mutation rate.
(S84) A new individual formed by randomly determining a target value of the focus explanatory variable, replacing the original value of the focus explanatory variable with the target value, and maintaining the values of the other explanatory variables is generated as a child individual.

The individual operation section 126b performs the processes of S82 to S84. When the focus explanatory variable is the continuous value type, and the maximum and minimum values are set as an individual constraint condition, the individual operation section 126b determines, as a target value, a real value of any one of continuous values within the range from the minimum value to the maximum value. When the focus explanatory variable is the discrete value type, the individual operation section 126b determines, as the target value, one candidate value randomly selected from a plurality of candidate values set as the individual constraint condition.

For example, for a focus explanatory variable ev3-2 which is a continuous value, a real value ev1-2′ within the range from the minimum value to the maximum value, which are set as the individual constraint condition, is randomly determined as a target value. For the focus explanatory variable ev3-1 which is a discrete value, one candidate ev3-1′ is randomly determined as a target value from candidates of a plurality of values set as the individual constraint condition. An explanatory variable group including the replaced value of the focus explanatory variable and the values of other explanatory variables is generated as a child individual ev3′.

When the focus explanatory variable is the combination type, the individual operation section 126b determines, as a target value of a plurality of explanatory variables, one combination randomly selected from a plurality of combinations including an explanatory variable set as the combination condition. The selected combinations may have a priority order similarly to the initial individual generation process and the crossover process, and a probability with which the individual operation section 126b selects, for example, a predetermined combination may be large or small. Further, the individual operation section 126b may not select a predetermined combination.

In the process of S82, the explanatory variable of the combination type may be regarded as one explanatory variable and may be selected at a predetermined mutation rate.

The selection section 126d calculates the fitness degree of each individual constituting the current generation data using a predetermined mathematical model. An index indicating a product performance is applied as the fitness degree. The selection section 126d selects n individuals from n parent individuals and newly generated child individuals in a descending order of the fitness degree, that is, by prioritizing individuals with a fitness degree that gives a good performance. The selection section 126d stores next generation data including the selected n individuals in the storage portion 140.

The product performance is generally evaluated using a plurality of factors. For example, when the product is a battery, an index that quantitatively indicates a capacity, an output, a cost, and the like can be an element. The capacitance corresponds to a charge that is discharged from when discharge starts until an end voltage is reached when an output voltage between electrodes is a rated voltage. The output corresponds to a current or electric power obtained by performing discharge when an output voltage is equal to the rated voltage. The cost is a manufacturing cost of the product. The cost may include various expenses required for processing, distribution, and the like, in addition to a unit price of each member.

Each element may be applied as the fitness degree. An index that integrates a plurality of elements may be applied as the fitness degree. A function that calculates the fitness degree by integrating element indices related to the plurality of elements may be a function that monotonically changes to a value that indicates a better performance when changing to a numeral value that indicates a good performance for each element. For example, the selection section 126d can calculate an element index αₖ using a learning model that has been learned for each element type k from an explanatory variable group of each individual, and calculate a weighted sum of the calculated element index αₖ between element types k as the fitness degree. In model learning, a parameter set of the learning model is determined in advance such that a predicted value of a target variable calculated using a learning model from a known explanatory variable group for each element type k and a target value of a target variable corresponding to the explanatory variable group are approximate to each other as an entire training data.

As a learning model, for example, any one of a linear model learned using multiple regression analysis, ridge regression, LASSO (Least Absolute Shrinkage and Selection Operator) regression, an elastic net, and the like, and a non-linear model such as a support vector machine, a neural network, adaboost, or random forest may be used. Further, a different learning model for each element type k may be used. A weight coefficient wk used for calculating the fitness degree is set in advance in the selection section 126d.

The analysis process portion 128 selects one or a plurality of individuals on the basis of the fitness degree calculated from the explanatory variable group from the individuals forming the product data stored in the storage portion 140. The analysis process portion 128 constitutes a display screen, for example, by associating an explanatory variable group of the selected individual and the fitness degree, and outputs display data indicating the constituted display screen to a display portion 160 (FIG. 2). The analysis process portion 128 may include the element index calculated from the explanatory variable group in the display screen in association with the explanatory variable group or the fitness degree.

The analysis process portion 128 may also evaluate a growth potential of the n parent individuals as a whole for each generation. An optimal value (hereinafter, may be referred to as an “optimal fitness degree”) of the fitness degree between individuals and a discreteness degree are included as a statistics amount for an index (hereinafter, may be referred to as a “growth index value”) of the growth potential. The discreteness degree is a degree in which values of an explanatory variable group do not concentrate in the vicinity of a specific value and are randomly distributed over an entire vector space. As an index indicating the discreteness degree, for example, any of a variance between individuals, an average distance between individuals, and the like may be used. In general, as an aggregation of individuals grows normally, a growth index value tends to increase, and a growth rate, that is, an amount of change thereof, tends to decrease. The analysis process portion 128 may output display data indicating a display screen including the growth index value to the display portion 160.

The storage portion 140 stores various data temporarily or permanently.

The input-output portion 150 allows various input data to be input to or output from other devices.

The analysis process portion 128 may output various display data to other devices via the input-output portion 150 instead of outputting the various display data to the display portion 160.

Various types of operation information may be input to the constraint condition-setting portion 124 and the individual process portion 126 from other devices via the input-output portion 150 instead of being input from the operation input portion 158. Other devices may be connected via a communication network.

Next, a hardware configuration example of the information-processing device 10 according to the present embodiment is described. FIG. 2 is a schematic block diagram showing a hardware configuration example of the information-processing device 10 according to the present embodiment. The information-processing device 10 includes a processor 152, an operation input portion 158, a display portion 160, a main memory 162, a program storage portion 164, an auxiliary storage portion 166, and an interface portion 168. The processor 152, the operation input portion 158, the display portion 160, the main memory 162, the program storage portion 164, the auxiliary storage portion 166, and the interface portion 168 are connected by a bus, and are capable of inputting and outputting various data from and to each other.

The processor 152 executes a calculation process instructed by a command described in various programs. The processor 152 controls an operation of the entire information-processing device 10. The processor 152 is, for example, a CPU (Central Processing Unit). In the present application, executing a calculation process instructed by a command described in a program may be referred to as “executing a program” or the like.

The operation input portion 158 is capable of receiving an operation and generates an operation signal in accordance with the received operation. Various types of operation information are instructed by the operation signal. The operation input portion 158 may include general-purpose members such as a mouse, a touch sensor, and a keyboard, or may include dedicated members such as a button and a dial.

The display portion 160 displays a display screen in accordance with display data input to the display portion 160. The display portion 160 may be any of a liquid crystal display, an organic electroluminescent display, and the like.

The main memory 162 is a writable memory used as a reading area of an execution program of the processor 152 or as a work area in which process data of the execution program is written. The main memory 162 includes for example, a RAM (Random-Access Memory).

The program storage portion 164 stores system firmware such as a BIOS (Basic Input Output System), firmware of various devices, other programs, and setting information required for executing the programs. The program storage portion 164 includes, for example, a ROM (Read-Only Memory).

The auxiliary storage portion 166 permanently stores various data and programs in a rewritable manner. The auxiliary storage portion 166 may be, for example, any of a HDD (Hard Disk Drive), a solid-state storage device (SSD: Solid-State Drive), and the like.

The interface portion 168 connects to other devices in a wired or wireless manner such that various data can be input and output. The interface portion 168 includes one or both of an input-output interface and a communication interface.

The processor 152 and the main memory 162 correspond to minimum hardware used for realizing a computer system of the information-processing device 10. The processor 152 mainly realizes functions of the calculation process part 120 by executing a predetermined program in cooperation with the main memory 162 and other hardware. The main memory 162, the program storage portion 164, and the auxiliary storage portion 166 realize a main function of the storage portion 140. The interface portion 168 realizes a main function of the input-output portion 150.

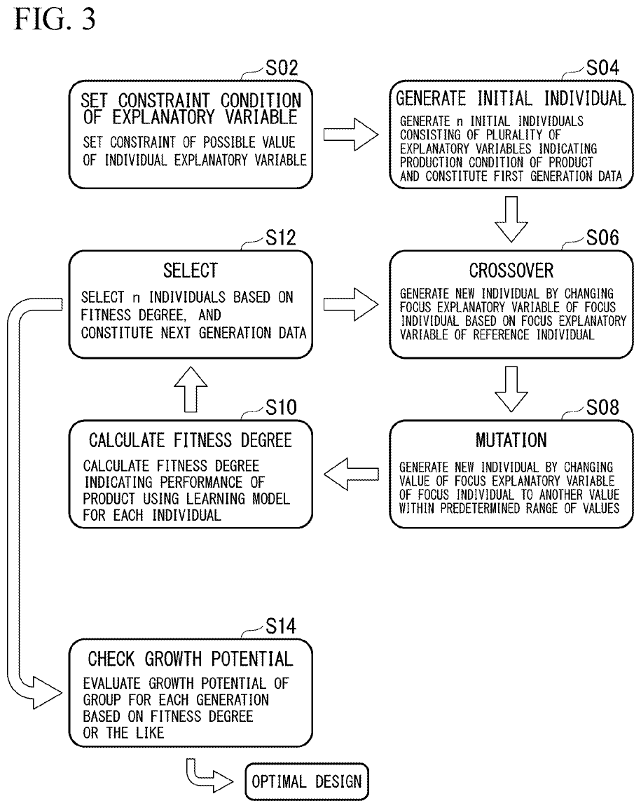

Next, an example of information processing according to the present embodiment is described. FIG. 3 is an overhead view showing an example of information processing according to the present embodiment.
(Step S02) The constraint condition-setting portion 124 sets an individual constraint condition applied to an individual explanatory variable and a combination condition applied to a plurality of explanatory variables as a constraint condition imposed on an explanatory variable group.
(Step S04) The generation section 126a generates n initial individuals constituted of a plurality of explanatory variables indicating a production condition of a product. The constraint condition verification section 126c verifies that all of the generated initial individuals satisfy the set constraint condition. The generation section 126a constitutes first generation data including the n initial individuals that satisfy the constraint condition as parent individuals and stores the first generation data in the storage portion 140.

The individual process portion 126 repeats processes of Steps S06 to S12 G times. G is an integer of 2 or more indicating a predetermined number of generations.
(Step S06) The individual operation section 126b repeatedly executes the crossover process in accordance with a predetermined crossover rate. The individual operation section 126b randomly selects a focus explanatory variable of a focus individual from the parent individuals in the crossover process. The individual operation section 126b generates a new individual by changing a value of the focus explanatory variable of the focus individual to a target value based on a value of a focus explanatory variable of a reference individual that is randomly selected. The individual operation section 126b includes the new individual as a child individual in the current generation data.
(Step S08) The individual operation section 126b repeatedly executes the mutation process in accordance with a predetermined mutation rate. The individual operation section 126b randomly selects a focus explanatory variable of a focus individual in accordance with the mutation rate from the parent individuals in the mutation process. The individual operation section 126b generates a new individual as a child individual by changing a value of the focus explanatory variable of the focus individual to a target value that is randomly selected within a range of values forming the constraint condition of the focus explanatory variable. The individual operation section 126b includes the new individual as a child individual in the current generation data.
(Step S10) The selection section 126d calculates a fitness degree indicating the performance of a product for each individual included in the current generation data.
(Step S12) The selection section 126d selects n individuals in a descending order of performance indicated by the fitness degree, constitutes next generation data including the selected n individuals, and stores the next generation data in the storage portion 140. Then, the routine returns to Step S06.
(Step S14) The analysis process portion 128 evaluates a growth potential of a group on the basis of the fitness degree of each individual or the like for each generation. For example, the analysis process portion 128 calculates an optimal fitness degree as a growth index value on the basis of the fitness degree of n individuals for each generation.

After the processes of Steps S06 to S12 are repeated G times, the analysis process portion 128 selects one or a predetermined number of individuals in a descending order of the fitness degree and outputs optimal design information indicating a production condition indicated by an explanatory variable group forming the selected individuals to the display portion 160 or another device.

Regardless of whether or not the number of generations G is set, the analysis process portion 128 may determine whether or not a growth of the product data has converged on the basis of the growth index value. For example, the analysis process portion 128 can determine whether or not a growth of the product data has converged according to whether or not the amount of change in the growth index value between generations decreases monotonically as the generations accumulate, and the amount of change becomes smaller than a predetermined threshold of the amount of change. The analysis process portion 128 may stop the processes of Steps S06 to S12 when it is determined that the growth has converged.

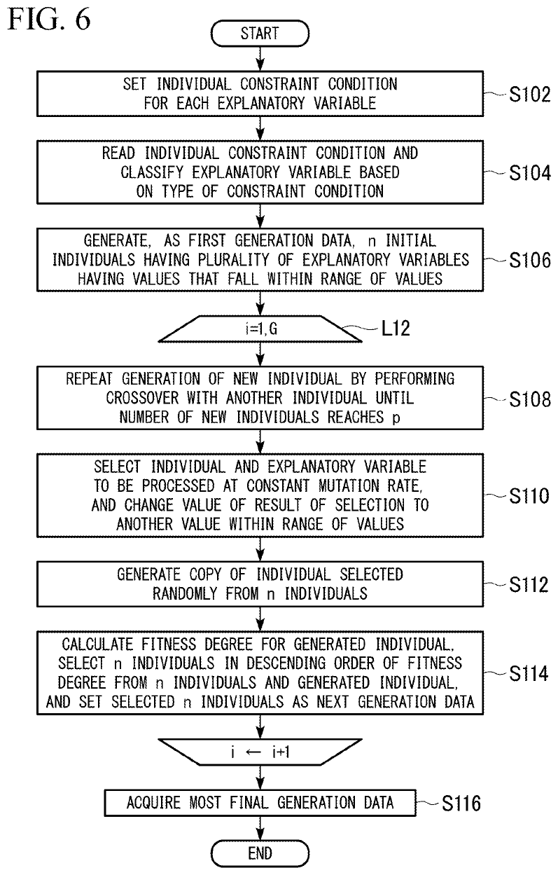

Next, another example of information processing according to the present embodiment is described. FIG. 6 is a flowchart showing another example of information processing according to the present embodiment. The example shown in the drawing mainly describes generation of an individual and a process for explanatory variables.
(Step S102) The constraint condition-setting portion 124 sets a constraint condition for each explanatory variable as a constraint condition. The constraint condition-setting portion 124 stores constraint condition information indicating the set constraint condition in the storage portion 140.
(Step S104) The generation section 126a reads the constraint condition from the storage portion 140. The generation section 126a specifies an explanatory variable to which the constraint condition is applied and classifies each explanatory variable on the basis of a type of the constraint condition.
(Step S106) The generation section 126a repeats a process of setting a value of an explanatory variable such that the value becomes a value instructed by the constraint condition and generates n initial individuals. The generation section 126a constitutes first generation data including the generated n initial individuals and stores the first generation data in the storage portion 140.

The process of a loop L12 includes the processes of Steps S108 to S114, and these processes are repeated G times. An initial value of the number of repetitions i is set to 1, and the individual process portion 126 counts the number of repetitions i by adding (incrementing) 1 to the number of repetitions i after the process of Step S114 is completed. When the number of repetitions i exceeds G times, the routine proceeds to the process of Step S116.
(Step S108) The individual operation section 126b randomly selects a focus individual to be processed by executing the crossover process and repeats the process of generating a new individual by crossing the selected focus individual with another reference individual until the number of new individuals reaches p.
(Step S110) The individual operation section 126b randomly selects a focus explanatory variable of the focus individual to be processed at a constant mutation rate, changes a value of the focus explanatory variable to a target value that is in a range of values forming the constraint condition, and generates a new individual.
(Step S112) The constraint condition verification section 126c rejects an individual having a reset value that deviates from the set range of values. The constraint condition verification section 126c randomly selects each one individual from the n individuals that are parent individuals in place of each rejected individual. The constraint condition verification section 126c generates a copy of the selected individual as a new individual and stores the copy in the current generation data.
(Step S114) The selection section 126d refers to the current generation data and calculates the fitness degree for each child individual, which is a newly generated individual, using a predetermined mathematical model from the explanatory variable group. The selection section 126d selects n individuals in a descending order of the fitness degree from the n parent individuals and the new child individual and stores next generation data including the selected n individuals in the storage portion 140.
(Step S116) The analysis process portion 128 reads the most final generation data stored in the storage portion 140 and selects one or more predetermined number of individuals from the read most final generation data in a descending order of the fitness degree. The analysis process portion 128 can determine the production condition indicated by the explanatory variable group of the selected individual as an optimal design condition. Then, the process of FIG. 6 is completed.

The above embodiment is described using an example in which in the information-processing device 10, the operation input portion 158 is connected to the display portion 160 in a wired or wireless manner, operation information is input from the operation input portion 158, and display data is output to the display portion 160; however, the present invention is not limited thereto. An input source of the operation information and an output destination of the display data may be an external device connected using a network. In that case, in the information-processing device 10, one or both of the operation input portion 158 and the display portion 160 may be omitted.

Although a mode for implementing the present invention has been described using the embodiments, the present invention is not limited to these embodiments, and various modifications and substitutions can be added without departing from the scope of the present invention.

What is claimed is:

1. An information-processing method executed by an information-processing device, the information-processing method comprising:
generating a new individual by changing a value of part of explanatory variables of an individual selected with a first probability from current generation data, which has n individuals (n is an integer of three or more) and in which each individual is an explanatory variable group having a plurality of explanatory variables, to a target value based on a value of a corresponding explanatory variable of another individual;
generating a new individual by changing a value of part of explanatory variables of an individual selected with a second probability from the current generation data to another value; and
selecting n individuals of next generation data from the n individuals and the generated individual based on a fitness degree calculated from an explanatory variable group for each individual,
wherein an explanatory variable having a value defined by a combination condition is set to take a value represented by one of a plurality of combinations constituted of a plurality of values determined in advance.

2. The information-processing method according to claim 1,
wherein an explanatory variable having a value that is not defined by a combination condition takes a value within a set range when the explanatory variable is a continuous value, and the explanatory variable takes one of a plurality of candidate values when the explanatory variable is a discrete value.

3. A computer-readable storage medium that stores a computer program causing a computer of an information-processing device to execute the information-processing method according to claim 1.

4. An information-processing device comprising:
a storage portion that stores current generation data which has n individuals (n is an integer of three or more) and in which each individual is an explanatory variable group having a plurality of explanatory variables; and
an individual process portion that generates a new individual by changing a value of part of explanatory variables of an individual selected with a first probability from the current generation data to a target value based on a value of a corresponding explanatory variable of another individual,
generates a new individual by changing a value of part of explanatory variables of an individual selected with a second probability from the current generation data to another value, and
selects n individuals of next generation data from the n individuals and the generated individual based on a fitness degree calculated from an explanatory variable group for each individual,
wherein an explanatory variable having a value defined by a combination condition is set to take a value represented by one of a plurality of combinations constituted of a plurality of values determined in advance.
